(19) United States
(12) Patent Application Publication
(10) Pub. No.: US 2024/0017337 A1
(43) Pub. Date: Jan. 18, 2024

(54) HACKSAW

(71) Applicant: INDUSTRO INTERNATIONAL CO., LTD., TAICHUNG CITY (TW)

(72) Inventor: KUO-CHAN HUANG, Taichung (TW)

(21) Appl. No.: 17/865,415

(22) Filed: Jul. 15, 2022

(51) Int. Cl. B23D 51/10; B23D 51/12

(52) U.S. Cl. CPC B23D 51/10; B23D 51/125

(57) ABSTRACT

A hacksaw frame includes a beam, a front handle, a rear handle, and a blade. The beam includes a front rectilinear section, a rear rectilinear section, and an intermediate rectilinear section raised from the front and rear rectilinear sections so that there is a distance between a lower edge of the intermediate rectilinear section and a base line of the beam that passes through lower edges of the front and rear rectilinear sections. The front handle is connected to the front rectilinear section of the beam. The rear handle is connected to the rear rectilinear section of the beam. The blade includes a front section connected to the front handle and a rear section connected to the rear handle. The intermediate rectilinear section of the beam increases a distance between a lower edge of the beam and an upper edge of the blade.

### BACKGROUND OF INVENTION

### 1. Field of Invention

The present invention relates to a hacksaw and, more particularly, to a hacksaw including a frame for properly holding a blade.

### 2. Related Prior Art

A conventional hacksaw includes a frame for holding a blade. The frame includes a handle, a bow connected to the handle, and a tension-adjusting mechanism carried by the handle. The bow includes a front section, a rear section, and an intermediate rectilinear section. The front section is in perpendicular to the rear section. The rear section is connected to the handle. The intermediate rectilinear section is a rectilinear section. A front end of the blade is connected to the front section of the bow. A rear end of the blade is connected to the tension-adjusting mechanism. The tension-adjusting mechanism is operable to adjust tension in the blade. The blade can easily be deformed and broken in an operation if the tension is too small. On the contrary, the blade can be broken even before an operation if the tension is too large. However, the rectilinear intermediate rectilinear section of the bow is not good for exerting a proper value of tension in the blade.

The present invention is therefore intended to obviate or at least alleviate the problems encountered in the prior art.

### SUMMARY OF INVENTION

It is the primary objective of the present invention to provide a reliable hacksaw.

To achieve the foregoing objective, the hacksaw frame includes a beam, a front handle, a rear handle, and a blade. The beam includes a front rectilinear section, a rear rectilinear section, and an intermediate rectilinear section raised from the front and rear rectilinear sections so that there is a distance between a lower edge of the intermediate rectilinear section and a base line of the beam that passes through lower edges of the front and rear rectilinear sections. The front handle is connected to the front rectilinear section of the beam. The rear handle is connected to the rear rectilinear section of the beam. The blade includes a front section connected to the front handle and a rear section connected to the rear handle. The intermediate rectilinear section of the beam increases a distance between a lower edge of the beam and an upper edge of the blade.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a hacksaw according to the preferred embodiment of the present invention;

FIG. 2 is a side view of a beam of the hacksaw shown in FIG. 1; and

FIG. 3 is a side view of the hacksaw shown in FIG. 1.

### DETAILED DESCRIPTION OF PREFERRED EMBODIMENT

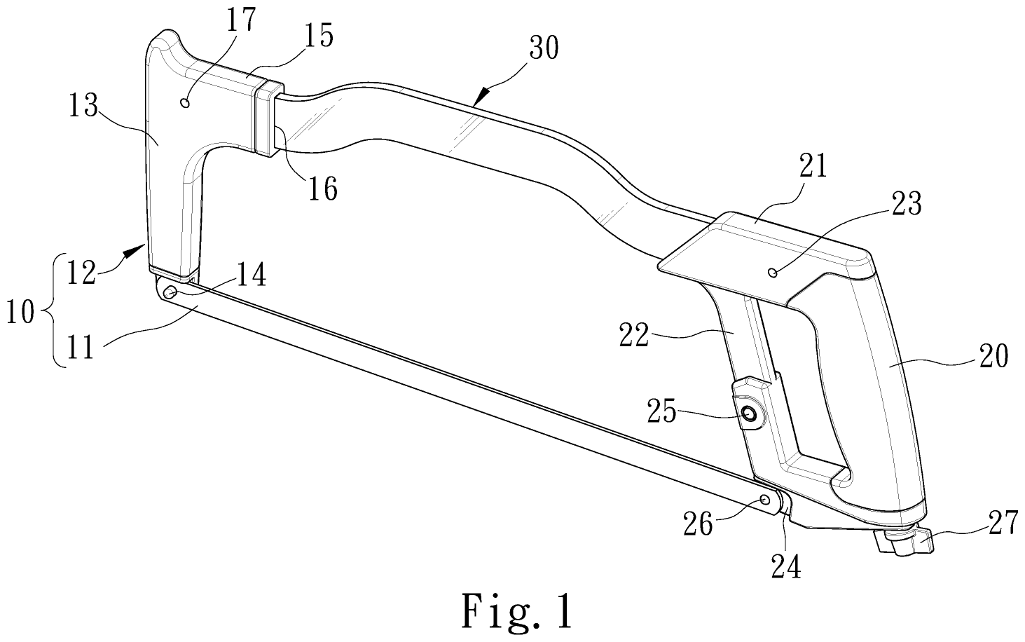

Referring to FIG. 1, a hacksaw 10 includes a blade 11 held by a frame 12 according to the preferred embodiment of the present invention. The frame 12 includes a beam 30, a front handle 13 connected to a front end of the beam 30, and a rear handle 20 connected to a rear end of the beam 30. A front end of the blade 11 is connected to the front handle 13. A rear end of the blade 11 is connected to the rear handle 20 via a tension-adjusting mechanism 24.

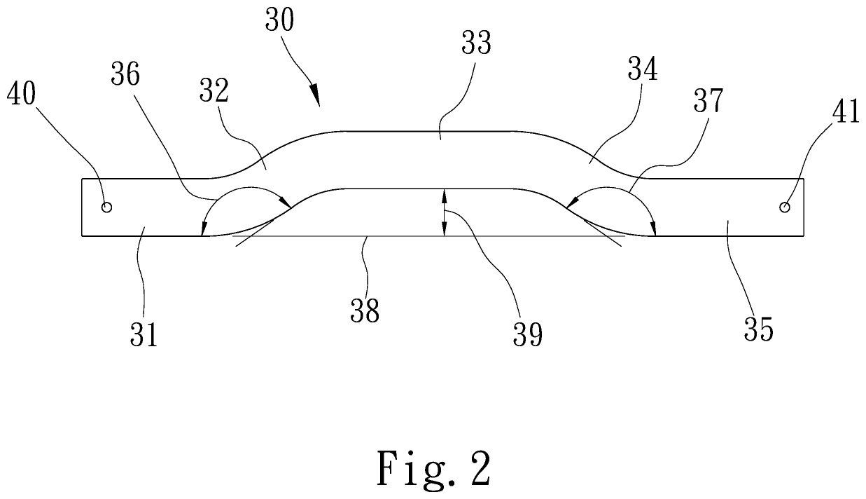

Referring to FIG. 2, the beam 30 includes a front rectilinear section 31, a front tilted section 32, an intermediate rectilinear section 33, a rear tilted section 34, and a rear rectilinear section 35. The front tilted section 32 extends between the front rectilinear section 31 and the intermediate rectilinear section 33. The rear tilted section 34 extends between the intermediate rectilinear section 33 and the rear rectilinear section 35. The front and rear tilted section 32 and 34 render the intermediate rectilinear section 33 like a hunch back in the middle of the beam 30.

There is an angle 36 between the front rectilinear section 31 and the front tilted section 32. There is an angle 37 between the rear tilted section 34 and the rear rectilinear section 35. The angles 36 and 37 are preferably 100° to 140°. A lower edge of the front rectilinear section 31 and a lower edge of the rear rectilinear section 35 extend along a base line 38 of the beam 30. There is a distance 39 between the base line 38 and a lower edge of the intermediate rectilinear section 33.

The front rectilinear section 31 includes an aperture 40. The rear rectilinear section 35 includes an aperture 41.

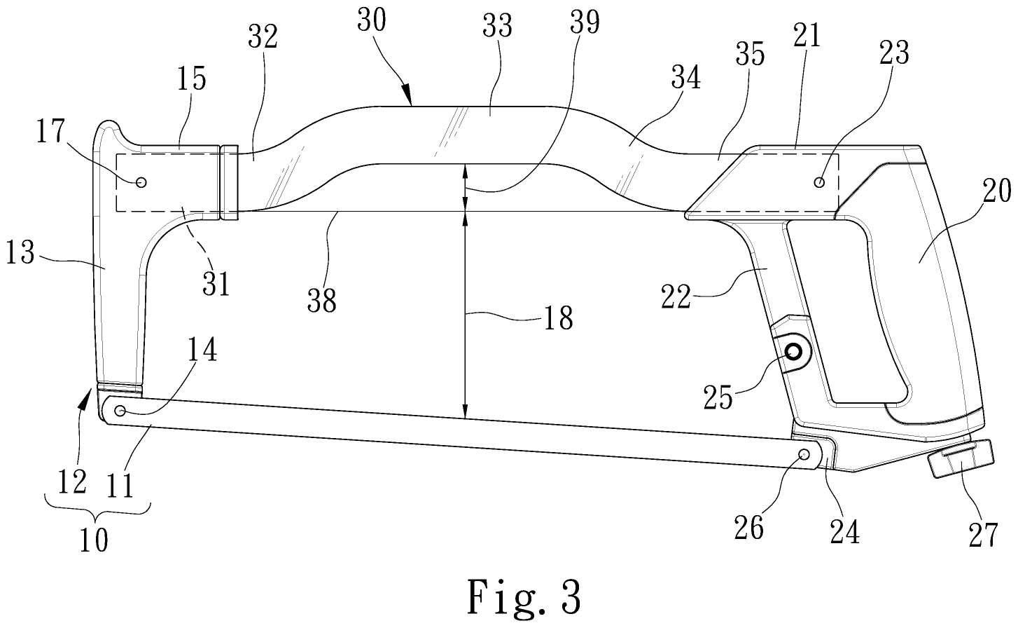

Referring to FIGS. 1 and 3, the front handle 13 includes a stationary pin 14 extending from a lateral side of a lower section and a sheath 15 extending from a rear face of an upper section. The front rectilinear section 31 is inserted in a bore 16 of the sheath 15 before a pin 17 is inserted in a lateral aperture (not numbered) of the sheath 15 and the aperture 40 of the front rectilinear section 31 of the beam 30. Thus, the front handle 13 is connected to the beam 30.

The rear handle 20 includes a sheath 21 extending from a front face of an upper section. The rear rectilinear section 35 is inserted in a bore (not numbered) of the sheath 21 before a pin 23 is inserted in a lateral aperture (not numbered) of the sheath 21 and the aperture 41 of the rear rectilinear section 35 of the beam 30. Thus, the rear handle 20 is connected to the beam 30.

The rear handle 20 further includes a handguard 22. The handguard 22 is an L-shaped element including a section connected to a lower face of the sheath 21 and another section connected to a front face of a lower section of the rear handle 20.

A tension-adjusting mechanism 24 is pivotally connected to the handguard 22 via an axle 25 at an end. The tension-adjusting mechanism 24 is connected to the lower section of the rear handle 20 via a knob 27. The tension-adjusting mechanism 24 is inserted in the handguard 22. The tension-adjusting mechanism 24 includes a movable pin 26 extending from a lateral side of the handguard 22.

The stationary pin 14 is inserted in an aperture (not numbered) in a front section of the blade 11. The movable pin 26 is inserted in an aperture in a rear section of the blade 11. Thus, the blade 11 is connected to the front and rear handles 13 and 20. The tension-adjusting mechanism 24 is operable to exert a proper value of tension on the blade 11.

The sum of the distance 39 between the lower edge of the intermediate rectilinear section 33 and the base line 38 of the beam 30 and a distance 18 between the base line 38 of the beam 30 and an upper edge of the blade 11 is larger than a distance between a lower edge of a beam of a frame of a conventional hacksaw and an upper edge of a blade. Thus, is easier to exert a proper value of tension on the blade 11 with the hacksaw 10 than with the conventional hacksaw.

The frame 12 exhibits several advantages. Firstly, there is a good balance between rigidity and flexibility of the beam 30 for using the front and rear tilted sections 32 and 34 to raise the intermediate rectilinear section 33.

Secondly, the hacksaw 10 is allowed to saw a thick workpiece because the sum of the distances 18 and 39 is large.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A hacksaw frame comprising:
a beam comprising a front rectilinear section, a rear rectilinear section and an intermediate rectilinear section raised from the front and rear rectilinear sections so that there is a distance between a lower edge of the intermediate rectilinear section and a base line of the beam that passes through lower edges of the front and rear rectilinear sections;
a front handle connected to the front rectilinear section of the beam;
a rear handle connected to the rear rectilinear section of the beam; and
a blade comprising a front section connected to the front handle and a rear section connected to the rear handle, wherein the intermediate rectilinear section of the beam increases a distance between a lower edge of the beam and an upper edge of the blade.

2. The hacksaw according to claim 1, wherein the beam further comprises a front tilted section extending between the front rectilinear section and the intermediate rectilinear section.

3. The hacksaw according to claim 2, wherein there is a first angle between the front rectilinear section and the front tilted section.

4. The hacksaw according to claim 3, wherein the first angle is 100° to 140°.

5. The hacksaw according to claim 1, wherein the beam further comprises a rear tilted section extending between the rear rectilinear section and the intermediate rectilinear section.

6. The hacksaw according to claim 5, wherein there is a second angle between the rear tilted section and the rear rectilinear section.

7. The hacksaw according to claim 6, wherein the second angle is 100° to 140°.
